(19) United States
(12) Patent Application Publication
(10) Pub. No.: US 2005/0234783 A1
(43) Pub. Date: Oct. 20, 2005

(54) Business method for on-demand product manufacturing and fulfillment system

(76) Inventor: Charles Marshall, Burbank, CA (US)

Correspondence Address: Zilka-Kotab, PC, P.O. BOX 721120, SAN JOSE, CA, 95172-1120, US

(21) Appl. No.: 10/826,554

(22) Filed: Apr. 15, 2004

(51) Int. Cl. G06F 17/60

(52) U.S. Cl. 705/27

(57) ABSTRACT

A method for earning money by web-based on-demand product manufacturing and fulfillment. The method includes hosting a website having products available for purchase. User input indicating selection of at least one of the products is received. A price for the selected product is calculated and payment information is requested from the user. Payment information is received from the user. The product is manufactured and prepared for shipping to the customer. The method is performed without human intervention.

### FIELD OF THE INVENTION

The present invention relates to on-demand manufacturing and fulfillment systems and more particularly, this invention relates to a business method for earning money using an automated on-demand manufacturing and fulfillment system.

### BACKGROUND OF THE INVENTION

Historically, items for sale have been sold by “brick and mortar” retailers who have a plurality of items in stock for purchase by customers. However, one problem faced by retailers is that substantial quantities of the products must be kept in stock to meet customer demand. This requires a substantial capital outlay. If the item is not in stock, the customer will go elsewhere to purchase the item. Another drawback is that the costs of rent, payroll, insurance and utilities leads to increased overhead. Further, significant floor space must be available to display the products for sale.

Online purchasing has provided new opportunities to increase sales and reduce the costs typically associated with traditional retail establishments.

In no industry has the Internet created greater opportunities for both legitimate sales and illegal downloading than in the entertainment industry. Online retailers such as CD NOW and AMAZON.COM resell already-produced CDs and DVDs to customers ordering online. However, such resellers are limited by the quantity of CDs/DVDs on hand. If the product is out of stock, the reseller must contact the supplier and order more product. Unfortunately, by the time the reseller receives the items, the customer has long gone. This marketing concept is basically the same model that a bookstore uses when they run out of an author's book.

Another drawback is that the resellers must often order large quantities of CDs or DVDs in order to obtain preferable pricing. Suppliers look to replication services in order to provide the media replication services require the client to: (1) make a glass master typically costing $1,200.00 to $2000.00, and (2) order a minimum of 1000 CD/DVDs in order to obtain a better pricing structure. Once the replicated product is completed the replication service will ship the final product to the supplier, all 1000 units for $1,100.00 to $1,500.00. Once the supplier calculates the amount of time and money spent for shipping and supplies, labeling cost, printing and 3.2% return rate due to manufacturing imperfections, the cost suddenly increases to $5,300.00 to $6,000.00.

Music sharing services such as NAPSTER and KAZAA once allowed millions of songs to be downloaded to users' computers via a platform based on “freeware shareware” and imprinted, or “burned” on CDs. However, the software did provide for payment of royalties to the record companies for the use of music. This has been the source of major conflict between major record labels, RIAA and the performing rights societies BMI and ASCAP.

From this debacle, several services allowing legal music downloading have emerged. Such services allow customers to download single songs or a compilation, but most of these online services do not sell completed CDs or DVDs as of yet, relying instead on the user having the proper equipment to burn their own media. A major hurdle for such services, however, has been the relatively small number of users having CD or DVD burning equipment, coupled with the lack of computing proficiency (at least with respect to creating media at home) in the large majority of the population.

What is therefore needed is a way to provide an unmanned automated manufacturing system with the ability to produce small to large quantities of products, thus allowing for a lower price-point.

What is also needed is a system that provides legal online music acquisition that gives the consumer the ability to pick and choose tracks from individual artists with the ability to customize their own CD with custom artwork.

What is further needed is a system that is less expensive as compared to the business practices of the entertainment conglomerates, as well as the on-demand manufacturing logistics vs. historical industry inventory practices for artist royalties in major label contracts.

What is still further needed is a system that provides artist preservation of proprietary rights-copyrights and has the flexibility to provide preferred artist payment schedules.

### SUMMARY OF THE INVENTION

The present invention provides the first true fully automated on-demand product manufacturing and fulfillment system capable of bringing high quality media and media services to multiple market segments. For instance, the custom media (e.g., CD/DVD) on-demand system and method of the present invention provide an innovative service that fulfills the needs of CD/DVD end-users, both professional and private, seeking an all-in-one alternative to mass produced CDs/DVDs. By offering a “one-stop” location manufacturing/duplication, fulfillment and distribution, present invention provides a convenient and economically efficient solution for producing the highest quality retail ready product obtainable.

At little or no cost to the content developer, this new business technology will bring success to a number of high volume industries. A short list of industries that could implement the system of the present invention would include: independent record companies, recording artists, film studios, school yearbook producers, auto manufacturers, infomercial producers, healthcare providers, videogame producers, movie companies, and television networks.

Accordingly, the present invention provides a method for earning money by web-based on-demand product (e.g., media) manufacturing and fulfillment. A website is hosted. The website, accessible to customers via computing devices connected to the Internet, has a listing of content available for purchase, as well as types of media that can be produced. User input indicating selection of content to be purchased by the customer is received, such as via a shopping cart on the website. The price of the selected content (and shipping if applicable) is calculated and payment information is requested from the user via a payment screen presented to the user. Payment information such as credit card number, credit card expiration date, bank account number, billing address, etc. are received from the user via the computing device. The ability to pay is verified, and payment is requested from the customer's agent (e.g., credit provider or bank). Alternatively, a user's online account can be charged for the purchase.

Once payment has been verified and/or secured, the system creates, labels, and packages the media with no human intervention. The system then prepares the media with no human intervention for delivery to the customer. Royalties can be calculated for each portion of the content on the media (or for the collection of content as a whole), and payment is made to the owner of the content (or their representative).

According to another embodiment, a process is provided for earning money by on-site on-demand media manufacturing and fulfillment. A catalog of content available for purchase is maintained locally on a computing device (e.g., PC, server, or handheld). The catalog is preferably resident in the computing device, such as in RAM, ROM, or on a removable storage medium. User input indicating the content to be purchased is received. Payment for the content (i.e., price) is calculated and requested. The magnetic stripe of the customer's credit or debit card is read via a reader. The ability to pay is verified, and payment is requested from the customer's agent (e.g., credit provider or bank). Alternatively, a user's online account can be charged for the purchase.

Once payment has been verified and/or secured, the system creates, labels, and packages the media with no human intervention. Because the system is local, the media is dispensed and can be retrieved by the customer or handed to the customer by a salesman.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a system diagram of an online automated on-demand manufacturing and fulfillment system according to one embodiment.

FIG. 2 is a system diagram of a system for providing automated online on-demand manufacturing and fulfillment for media.

FIG. 3 is a typical hardware configuration of a computing device according to one embodiment.

FIG. 4 is a graphical depiction of a simplified user interface of a website.

FIG. 5 is a graphical depiction of a simplified payment and shipping information user interface of a website.

FIG. 6 is a perspective view of a kiosk according to one embodiment.

FIG. 7 is a perspective view of a handheld computing device.

FIG. 8 is a process diagram of a process for earning money by web-based on-demand product (e.g., media) manufacturing and fulfillment.

FIG. 9 is a process diagram of a process for earning money by on-site on-demand media manufacturing and fulfillment.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

On-Demand Manufacturing and Fulfillment System

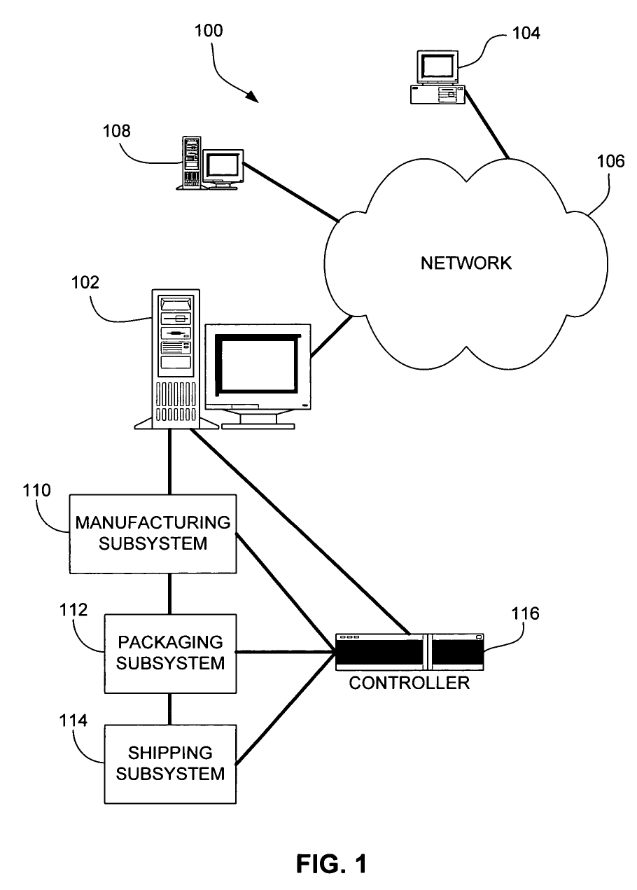

FIG. 1 illustrates a system 100 for an online automated on-demand manufacturing and fulfillment system according to one embodiment. This system, when initiated with full magazines of components, labels, packaging, etc., does not require any human intervention to create an item and prepare the item for shipping. As shown, the system includes a server 102 in communication with a customer computing device 104 via a communications link 106 such as the Internet. When the customer orders a product on his or her computing device, the server receives the order and requests and verifies payment from a third party server 108 that can authorize payment on behalf of the customer, again via a communications link such as the Internet. The item ordered by the customer is manufactured via an automated manufacturing subsystem 110. The manufactured item is then sent to a packaging subsystem 112 that places the item in a presentation package that can include an identification of the contents of the presentation package, instructions for use, artwork, etc. The presentation package with the item therein is sent to a shipping preparation subsystem 114 that places the presentation package into a shipping container such as a box or envelope, adds the customer's delivery address and postage or delivery payment information to the container. A controller 116 (which can be hardware or software under control of the server) coordinates the operations of the various subsystems.

For simplicity and to aid the understanding of the reader by placing the present invention in a context, the following description shall refer to a system for on-demand manufacturing and fulfillment for media. However, it should be understood that the present invention can be adapted for manufacture of any type of article of manufacture.

On-Demand Manufacturing and Fulfillment System for Media

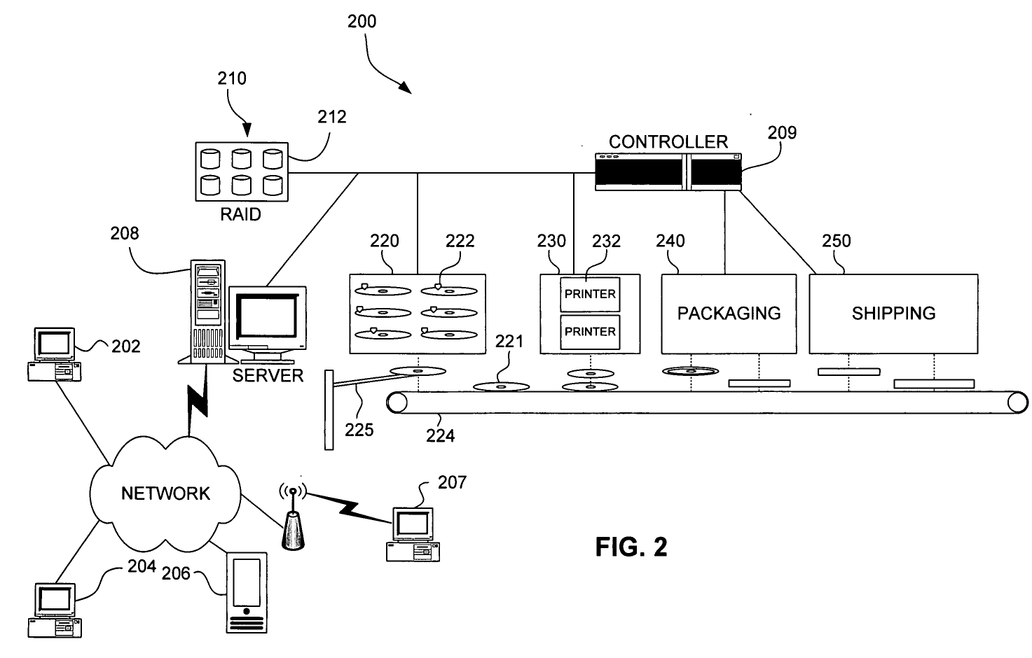

FIG. 2 illustrates a system 200 for providing automated online on-demand manufacturing and fulfillment for media. The term “media” as used herein is broadly construed to include any kind of tangible medium (e.g., compact disc (CD), digital video disc (DVD), videotape (VHS tape), etc.) containing content including but not limited to audio, video, text, software, tables, photos, and combinations thereof.

A short list of industries that could implement the system of the present invention include: retail, independent record companies, recording artists, film studios, software providers, video gaming, school yearbook producers, auto manufacturers, infomercial producers, healthcare providers, videogame producers, movie companies, and television networks.

As shown, several computing devices 202-207 are provided. The first device 202 is a personal computer at a user's home or office. The second device 204 is a computing device at a retail location to allow ordering of media directly from a retailer's location. The second device can also be a personal computer. The third device 206 is a handheld device, which is described in more detail below. The fourth device 207 includes a wireless link.

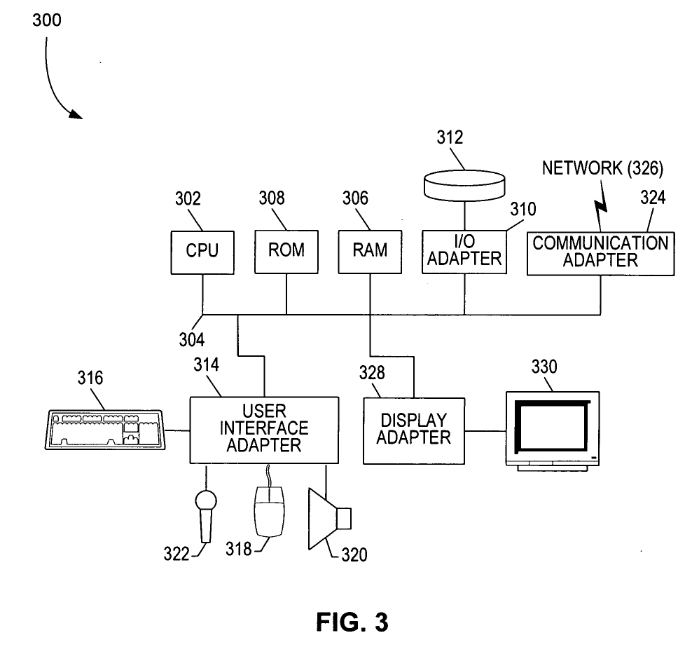

FIG. 3 illustrates a typical hardware configuration of a computing device 300 according to one embodiment. As shown, the computing device has a central processing unit 302, such as a microprocessor, and a number of other units interconnected via a system bus 304. The computing device also includes a Random Access Memory (RAM) 306, Read Only Memory (ROM) 308, an I/O adapter 310 for connecting peripheral devices such as disk storage units 312 to the bus, a user interface adapter 314 for connecting a keyboard 316, a mouse 318, a speaker 320, a microphone 322, and/or other user interface devices such as a touch screen and a digital camera (not shown) to the bus, communication adapter 324 for connecting the workstation to a communication network 326 (e.g., a data processing network or the Internet) and a display adapter 328 for connecting the bus to a display device 330.

The workstation may have resident thereon an operating system such as the Windows Operating System (OS), the IBM OS/2 operating system, the MAC OS, the LINUX operating system, or UNIX operating system.

From any of these devices, a customer (or one acting on the customer's behalf) enters an order for content. The available content can be presented via a website listing the content. Preferably, the website is searchable by keyword, artist, type of content, etc.

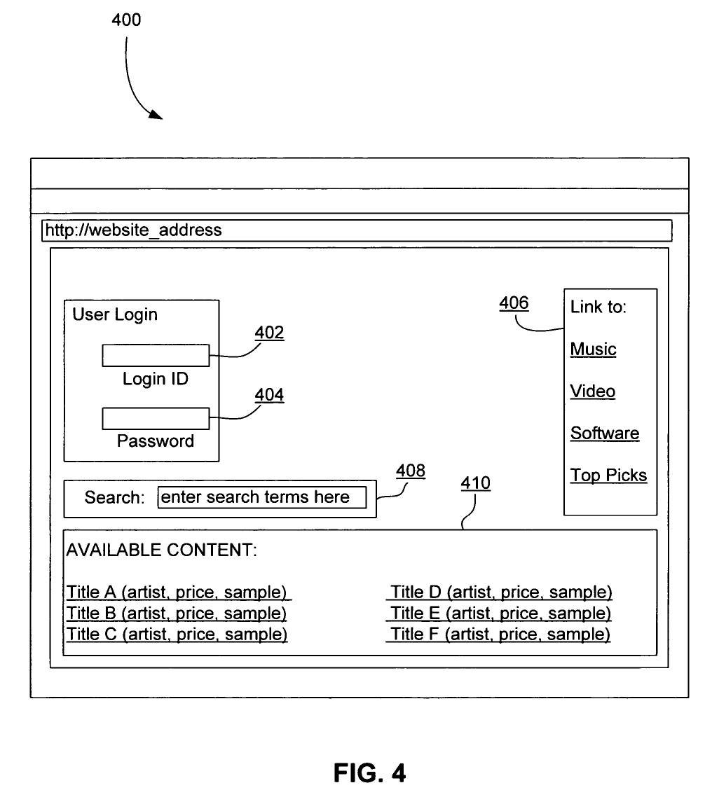

FIG. 4 illustrates a simplified user interface 400 of the website. The user interface includes a login field 402 and a password field 404 for allowing the user to login to his or her account. The user interface also includes quick links 406 to various content types, a search field 408, and a list of content 410.

The customer also enters payment information (credit card, online account (e.g., PAYPAL), etc.) and shipping information (e.g., customer address) via an appropriate user interface. Note that some or all of this information can also be stored as part of a user's account. The user could then merely log in to the system and indicate the desired content such as by placing a representation of the content in a shopping cart.

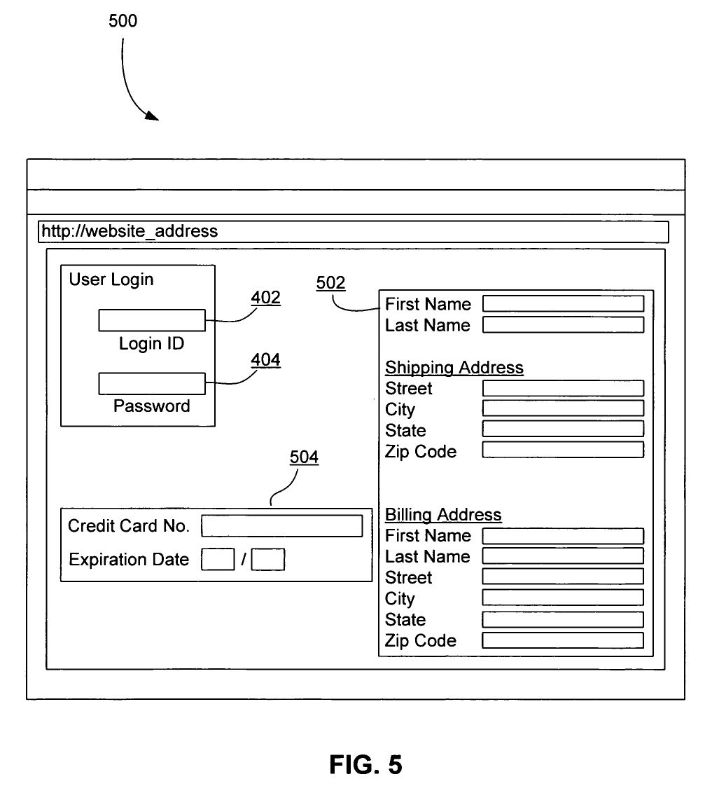

FIG. 5 illustrates a simplified payment and shipping interface 500. The interface includes address fields 502 and a field 504 for entry of credit card information.

With continued reference to FIG. 2, the computing devices communicate via a communication link with a secure network server 208 that hosts the website, receives the order, address, payment information, and/or login information. It should be understood that the “server” need not be a single machine, but can include not only redundant systems but also multiple systems that are each responsible for performing a specific collection of tasks. The server may have resident thereon the Windows Operating System (OS), the IBM OS/2 operating system, the MAC OS, the LINUX operating system, or UNIX operating system. It will be appreciated that a preferred embodiment may also be implemented on platforms and operating systems other than those mentioned. A preferred embodiment may be written using JAVA, C, and/or C++ language, or other programming languages, along with an object oriented programming methodology. Object oriented programming (OOP) has become increasingly used to develop complex applications.

Payment for the order is requested and verified automatically by the server, such as by contacting the credit card company, accessing the user's online account with a third party provider, etc. Alternatively, the customer may have a deposit account with the system, from which payment is debited.

Coordination software running on the server or, as shown, a controller 209, manages the following subsystems to ensure that the product is created and labeled correctly and sent to the appropriate customer. The server (or other computing device) can interconnected to each of the other subsystems in the system by an Ethernet connection, wireless connection, etc. In a preferred embodiment, each physical object in the manufacturing, labeling, packaging, and shipping preparation processes has a barcode, RFID tag, or other suitable identification means that is tracked by lasers, RFID readers, etc. as the various components that make up the finished product travel along the automated assembly line.

The coordination software also allows the system to produce different pieces of media having the same or different content simultaneously, thereby greatly increasing the speed with which media can be produced.

The order is routed to a storage subsystem 210 such as a Redundant Array of Inexpensive Disks (RAID) box 212 containing content in digital format, label information, artist information, copyright information, etc.

The content matching the order is selected (e.g., by filename, collection set, etc.) and sent to a duplicator subsystem 220 which creates media 221 (e.g., CD, DVD, VHS tape, etc.) containing the selected content in a format readable by conventional playback devices (e.g., CD drive, DVD player, videocassette player, home stereo, car stereo, etc.). For instance, if a CD is ordered, a CD burner of a type known in the art is used to create the media on a writable CD (e.g., CD-R). If a DVD is ordered, a DVD burner of a type known in the art is used to create the media on a writable DVD (e.g., DVD-R, DVD+R).

Preferably, the duplicator subsystem has multiple writers 222 all capable of creating independent media of different content simultaneously under the control of the coordination software.

In a preferred embodiment, the duplicator subsystem includes a magazine of blank media, a mechanism for inserting the blank media in the writers, the writers themselves, and a mechanism for removing the written media from the writers and placing the written media on a conveyor belt 224 via a transportation mechanism 225 for further processing.

The label information is sent to a labeling subsystem 230 which can either print labels having indicia thereon for affixing to the media, or can print the label information directly on the media. Illustrative media information includes the title of the collection of works, a song list, a list of video chapters, artist information, copyright information, logos, record or movie company names, etc.

The labeling subsystem, according to a preferred embodiment, includes multiple printers 232 acting under the direction of the coordination software. The printers autoload labels from a magazine or roll of labels and print images and text on them corresponding to media. The labels are then coordinated with and coupled to the appropriate media the direction of the coordination software as the media travels along the conveyor belt under.

A packaging subsystem 240 places the labeled media in a presentation package, such as a jewel case, etc. via any suitable mechanism. Labels, liners, artwork, booklets, etc. can also be added to the presentation package by the packaging subsystem. These items are also printed, folded (if necessary), and added to the presentation packages automatically.

The packaging subsystem can also seal the presentation packages via shrink wrap, labels, etc. and return the presentation packages to the conveyor belt.

A shipping preparation subsystem 250 inserts the presentation packages with media therein into shipping containers using any suitable apparatus, as will be understood by those skilled in the art of packaging. The coordination software matches the shipping information to the presentation packages traveling down the conveyor belt. Preferably, a shipping container (e.g., box, envelope, etc.) of appropriate size and durability is selected based on the quantity and size of the media ordered. For instance, the size of the interior of the container can be about the same size as the collective size of the media where multiple media are to be sent to the same address. Note that the system can also split larger groups of media into two or more shipping containers. Also, if the user has selected expedited shipping, packaging for expedited shipping can be used. For example, a U.S. Postal Service Express Mail package can be selected.

Customer address information is extracted from the shipping information and used to add the shipping (customer) and return addresses to the shipping container such as via labels or direct imprint on the container. This step can be conducted either before or after the media are placed in the shipping containers.

Postage is calculated (if applicable) by any suitable means including estimating the weight or directly weighing the packaged product and providing sufficient postage, determining a preset or “fixed” price for shipping with the type of container or shipping service selected, etc. The shipping subsystem adds the postage to the shipping container via labels or direct imprint on the packaging. Alternatively, for shipping providers who charge per package via a corporate account, the corporate account number can be placed on the container or label. The shipping provider will determine the shipping cost and request payment at a later date.

As an option, a tracking number (if applicable) can be sent to the customer by email, on a paper invoice, etc.

Backend functionality of the system includes tracking and paying royalties, generating internal and sharable statistics on sales, etc. These and other functions are described in more detail below.

According to a preferred embodiment, the only human intervention required by the system is reloading magazines for media, printer, packaging, shipping containers; transporting the final product to the shipper; and periodic maintenance. Alternatively, the items for shipment can be merely consolidated in an area where the shipper can retrieve them.

The on-demand systems described hereinabove provide several advantages. First, media (and other articles of manufacture) can be produced and shipped within 24 hours or less from the time they are ordered by the customer. Also, cash flow is leveraged by eliminating up front costs. For instance, the system removes the initial investment barrier that can hinder small businesses, individuals, and others from producing their products. The customer can change his or her product fulfillment schedule or content at any time prior to shipping. Similarly, the manufacturer can create products without worrying about new production costs or out-dated inventory. Overstocking of inventory is reduced or eliminated. Further, products can now be offered even where the demand is uncertain or where demand exceeds forecasts.

Retail

The system also provides traditional retail support. As mentioned above, one of the computing devices can be placed in a retail environment such as in a department store, music store, video store, etc. At the retail location, the user can browse the physical inventory of the store, a listing of products, and/or can view graphical and audible representations of the media via graphical user interfaces, headphones, listening modules, etc. The user can then select the desired item and order the item via the computing device (which may or may not be integrated with the graphical user interfaces, listening modules, etc.). The user also enters payment (e.g., credit card information, gift card information, etc.) and personal identification information (e.g., shipping and billing address(es), ID and password, etc.). The computing device recognizes the item(s) selected and payment and personal identification information and generates an order. The computing device then sends the order to the server of the system. Any feedback from the server can be output to the customer. Also, a receipt and confirmation can be printed at the computing device. The item is then produced and sent to the customer.

In an alternate embodiment, the customer can indicate to sales personnel what they want to purchase. The sales person then performs the aforementioned entry into the computing device.

In yet another embodiment, the system is present at the retail location for creation of media in real time.

In a further embodiment, the retailer orders a quantity of an item to have in stock. Once any inventory item is depleted, or the customer inventory tracking system issues an automatic re-order, new orders can be shipped within 24 to 48 hours.

One advantage to the retailers is that they will never be overstocked with large quantities of slow moving products. The retailer need only order what is needed. Another advantage is that the retailer can offer a larger variety of products in a smaller floor space.

Kiosk

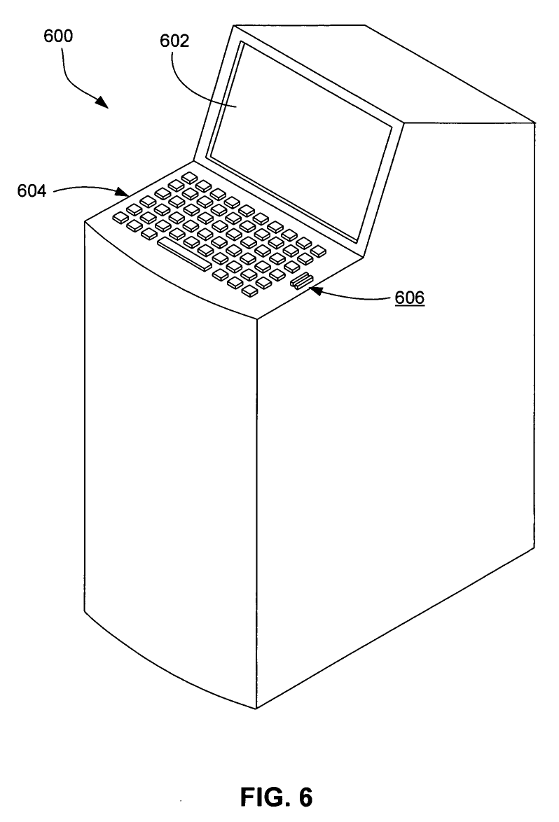

One of the computing devices can also be placed in other areas where customers might be found, such as in shopping malls, airports, at the beach, etc. Again, the item ordered can be produced off-site, or can be created and delivered at the point of sale. FIG. 6 illustrates a kiosk 600 according to one embodiment. As shown, the kiosk includes a display 602 and a keyboard 604 for receiving user input. In an alternate embodiment, the kiosk can be provided with a touch-screen display for receiving user input. A card reader 606 of a type known in the art reads a credit or debit card swiped therethrough.

Handheld Ordering

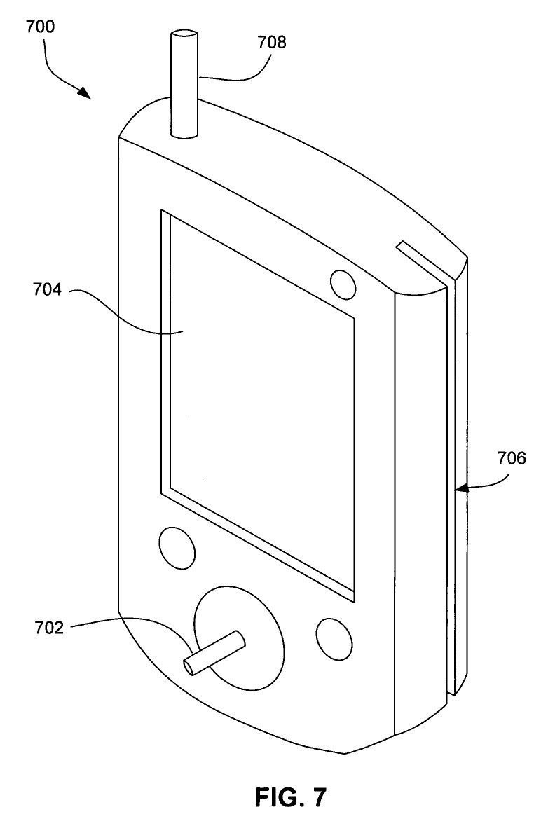

FIG. 7 illustrates a handheld computing device 700 which the customer (or one acting on behalf of the customer) can use to order an item. The handheld device includes an input device 702 for receiving user input. The input device can be a keyboard, mouse, touchpad, navigation stick, touch screen, etc. A graphical interface 704 displays such things as what is being input by the user, a list of available products, information about a particular product, order confirmation, account information, etc.

The handheld device also preferably includes a card reader 706 of a type known in the art. The card reader reads a credit or debit card swiped therethrough.

Upon compiling the order, the handheld device transmits the order to the server via a wireless link connected to a communications link, a docking station connected to the Internet, etc. An antenna 708 is provided for wireless communications.

Case Example: Concert

Musicians often attempt to sell their CDs at concerts. However, there are several drawbacks to this approach. First, the musicians must either hire additional staff to man sales booths or allow third party resellers to sell the CDs at the concert. In either situation, the overhead associated with such sales is very high. Second, the musicians must invest money up front to purchase the CDs that they wish to sell. Third, the potential for theft of CDs exists, particularly in very busy locals where the vending staff is busy helping customers. Fourth, the potential for error or theft regarding the handling of customer's money also exists. What is therefore needed is a way to provide a simple solution to these problems while maintaining high sales.

The fixed and handheld computing devices and kiosks described above can be provided at the concert to allow concert-goers to order CDs and DVDs on the spot. The customer simply swipes their credit card. The 24 hour a day 7 day a week operation of the automated manufacturing process begins to create the product almost immediately. Within 48 hours the customer receives their new product.

Case Example: Direct Offering from Artist

With record companies signing fewer and fewer new artists and more established artists refusing to renew their contracts due to the large premium charged by record companies, a tremendous void has been created, not only to the content producers but also the end-users. In years 2001-2003 major record companies released 30% less product than in the previous years, and no singles, which represent over $6 billion in loss revenue to the major labels. This leaves the independent record labels and artist seeking an alternative method to bring their products to market. The same would apply to independent film, software, and video-game producers.

Accordingly, the present invention provides a cost-effective means for distributing content created by a content creator who would otherwise not have a large-scale outlet for his or her music. For the established artist, the present invention provides an outlet for content without the high overhead that has become standard with record and administrative companies. The artists can also rest assured that royalties will be paid to them for each copy of the artist's work sold.

The artist, author, or their representative would simply submit an electronic copy of their content to the system, along with any pertinent description of the content and artwork. The content and related description/artwork would then be made available to customers. A “do-it-yourself” form could be filled out by the content creator to allow automatic addition of the content and related description/artwork to the system.

Music/Video Platform

A web based server hosts a website containing searchable lists of songs, compilations (e.g., albums), and movies stored in a catalog of, and information relating to the songs/movies, such as artist, actors, author, director, etc. The website includes a shopping cart to which a user adds songs for compiling an order. The website also includes a list of artwork and labeling options, allowing the customer to customize the label that will eventually be added to the media. Upon placing the order, the system creates the corresponding media and prepares it for shipment.

Music Administration:

The system can also provide music administration services. Music administration encompasses a variety of services, including the supervising of the financial and copyright matters of songs, including payment of royalties and other fees when content is sold to third parties. Generally, music administration services are provided to songwriters through publishing companies, independent music administrators, law firms, or business managers. However, these firms often charge as much as 15-20% of total sales for administrative costs. Because the present invention is fully automated and software driven, a reduced rate and/or flat fee can be charged for administration. For instance, a royalty can be calculated and submitted to the author (or his representative) when media is produced and sold. Other costs such as advertising fees, etc. can also be calculated and submitted to the appropriate parties.

Copyright Protection

According to another aspect of the present invention, an artist may submit works directly to the system via upload, etc. with a request to register the artist's works with the U.S. Copyright Office. Forms need to be filed with the Copyright Office in order for the songwriter to seek formal copyright protection. Registration consists of the completion of a Form PA and should include a tape copy of the unpublished work. Registration of the master recording or sound recording is performed by submitting a Form SR for the sound recording. A registration fee must also be submitted.

The system is capable of automatically filling out the forms based on user input; creating media with the artist's works thereon; printing the forms and a check for the registration fee (or request for payment from a deposit account); packaging the media, payment, and forms in a shipping container; addressing the container to the U.S. Copyright Office; and adding postage or account number for shipping charges to the container.

Performing Rights

The songwriter and publisher are entitled to receive royalties when their song is performed, recorded or live, on radio and television, and through surveyed media such as the Internet, live concerts and programmed music services. These royalties are paid to both the composer and publisher through their performing rights organization of choice.

The performing rights organization grants licenses to perform the music in their respective repertoires to thousands of users of music in public places, such as broadcasting stations, hotels, clubs, colleges, restaurants, stores, etc. There are three performing rights organizations in the United States from which the songwriter and publisher can choose ASCAP, BMI and SESAC. After choosing the performing rights organization they want to join, paperwork needs to be filed to join the society and to register songs. If the songwriter's work is performed in a movie or on television, a music cue sheet also needs to be secured and provided to the society for payment of royalties.

CHARLIE, WHAT DOES YOUR SYSTEM DO FOR THIS ASPECT?

Licensing

Mechanical License:

The “mechanical” right is the right to reproduce a piece of music onto records or tapes. As long as at least the statutory mechanical royalty rate is paid, anyone can record a song that has already been commercially recorded with authorization (“compulsory” license). The mechanical license must be secured from the music creator.

Synchronization License:

When reproduction of music is made onto a soundtrack of a film or TV show, the reproduction is called “synchronization,” and the license that the TV or film producer needs to obtain is called a synchronization or “synch” license.

Master-Use License:

A master-use license should be secured when the sound recording is being reproduced either in the soundtrack of a film or TV show, or in compilation records.

All of the above copyright and licensing protection documents requires extensive paperwork in issuing licenses, tracking, and payment of fees and royalties. The system is preferably able to track the proper paperwork requirements for the customer, calculate the appropriate royalty, and submit payment to the appropriate parties.

CHARLIE, PLEASE ELABORATE

Business Methods

The present invention provides several business methods.

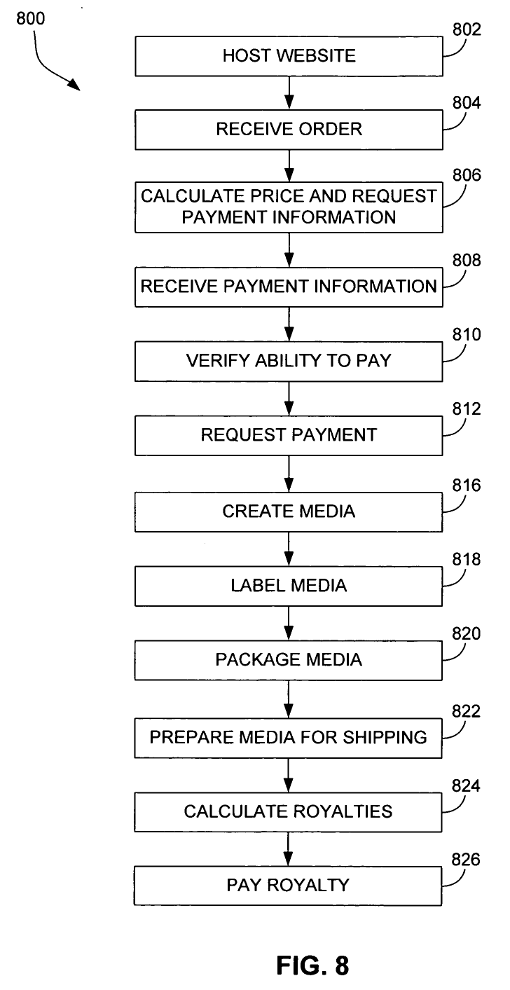

FIG. 8 illustrates a process for earning money by web-based on-demand product (e.g., media) manufacturing and fulfillment. In operation 802, a website is hosted. The website, accessible to customers via computing devices connected to the Internet, has a listing of content available for purchase, as well as types of media that can be produced. User input indicating selection of content to be purchased by the customer is received in operation 804, such as via a shopping cart on the website. In operation 806, the price of the selected content (and shipping if applicable) is calculated and payment information is requested from the user via a payment screen presented to the user. Payment information such as credit card number, credit card expiration date, bank account number, billing address, etc. are received from the user via the computing device in operation 808. The ability to pay is verified in operation 810, and in operation 812, payment is requested from the customer's agent (e.g., credit provider or bank). Alternatively, a user's online account can be charged for the purchase.

Once payment has been verified and/or secured, the system creates, labels, and packages the media with no human intervention in operations 816-820. In operation 822, the system then prepares the media with no human intervention for delivery to the customer.

In operation 824, royalties are calculated for each portion of the content on the media (or for the collection of content as a whole), and in operation 826, payment is made to the owner of the content (or their representative).

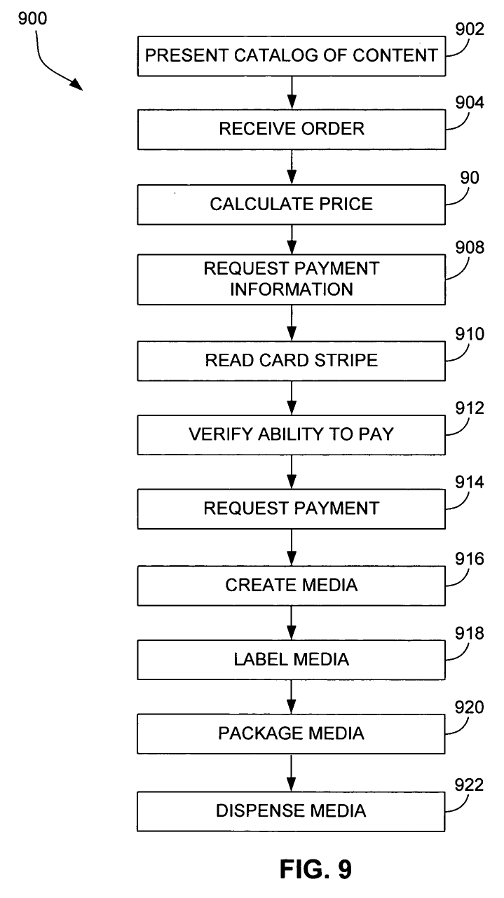

FIG. 9 illustrates a process for earning money by on-site on-demand media manufacturing and fulfillment. In operation 902, a catalog of content available for purchase is maintained locally on a computing device (e.g., PC, server, or handheld). The catalog is preferably resident in the computing device, such as in RAM, ROM, or on a removable storage medium. User input indicating the content to be purchased is received in operation 904. Payment for the content is calculated in operation 906 and requested in operation 908. The magnetic stripe of the customer's credit or debit card is read in operation 910 via a reader. The ability to pay is verified in operation 912, and payment is requested from the customer's agent (e.g., credit provider or bank) in operation 914. Alternatively, a user's online account can be charged for the purchase.

Once payment has been verified and/or secured, the system creates, labels, and packages the media with no human intervention in operations 916-920. Because the system is local, the media is dispensed in operation 922 and can be retrieved by the customer or handed to the customer by a salesman.

Accordingly, there has been described hereinabove a system for automated on-demand manufacture and fulfillment of products. The 24 hour a day, 7 day a week, unmanned automated manufacturing system will have the ability to produce high quantities, thus allowing for a lower price-point. The system can also include a mobile handheld device that allows artist/bands and game developers to sell their product on-site as they tour large and small night clubs and arenas, as well as trade shows worldwide. Music administration services that all musicians and content developer need are provided at a reduced cost. The system also provides legal online music acquisition that gives the consumer the ability to pick and choose tracks from individual artists with the ability to customize their own CD with custom artwork.

For the commercial end-user, the system is capable of fulfilling an on-demand request for any number of media (numbering 1 unit or 1,000,000 units), take a credit card order, and fulfill the delivery safely and securely. The primary market drivers that make the present invention particularly advantageous include: 1) the business practices of the entertainment conglomerates, 2) the on-demand manufacturing logistics vs. historical industry inventory practices for artist royalties in major label contracts, 3) artist preservation of proprietary rights-copyrights, and, 4) preferred artist payment schedules.

By extension, the present invention can be used to produce any type of product. The user, instead of selecting content for placing on media, selects configuration options for products, upon which the product is automatically produced, labeled, packaged, and prepared for shipping.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method for earning money by web-based on-demand product manufacturing and fulfillment, comprising:
hosting a website having products available for purchase;
receiving user input indicating selection of at least one of the products;
calculating a price for the selected product;
requesting payment information from the user;
receiving payment information from the user;
manufacturing the product; and
preparing the product for shipping to the customer;
wherein the method is performed without human intervention.

2. The method as recited in claim 1, wherein the payment information received from the user includes credit card information.

3. The method as recited in claim 1, wherein the payment information received from the user includes debit card information.

4. The method as recited in claim 1, wherein the payment information received from the user includes online account information.

5. The method as recited in claim 1, further comprising verifying an ability of the user to pay.

6. The method as recited in claim 1, further comprising labeling the product without human intervention.

7. The method as recited in claim 1, further comprising packaging the product in a presentation package without human intervention.

8. The method as recited in claim 1, wherein the product is media.

9. The method as recited in claim 8, wherein the media is selected from a group consisting of compact disc (CD), digital video disc (DVD), and videotape.

10. The method as recited in claim 8, wherein the user input further indicates selected content to be placed on the media, the content being selected from a group consisting of audio, video, text, software, tables, photos, and combinations thereof.

11. The method as recited in claim 10, further comprising calculating a royalty payment for the selected content.

12. A method for earning money by web-based on-demand media manufacturing and fulfillment, comprising:
hosting a website having content available for purchase;
receiving user input indicating selection of some of the content;
calculating a price for the selected product;
requesting payment information from the user;
receiving payment information from the user;
manufacturing the media having the selected content; and
preparing the media for shipping to the customer;
wherein the method is performed without human intervention.

13. The method as recited in claim 12, wherein the payment information received from the user includes credit card information.

14. The method as recited in claim 12, wherein the payment information received from the user includes debit card information.

15. The method as recited in claim 12, wherein the payment information received from the user includes online account information.

16. The method as recited in claim 12, further comprising verifying an ability of the user to pay.

17. The method as recited in claim 12, further comprising labeling the product without human intervention.

18. The method as recited in claim 12, further comprising packaging the product in a presentation package without human intervention.

19. The method as recited in claim 12, wherein the media is selected from a group consisting of compact disc (CD), digital video disc (DVD), and videotape.

20. The method as recited in claim 12, wherein the content is selected from a group consisting of audio, video, text, software, tables, photos, and combinations thereof.

21. The method as recited in claim 20, further comprising calculating a royalty payment for the selected content.

22. A method for earning money by on-site on-demand media manufacturing and fulfillment, comprising:
presenting a catalog on a local computing device, the catalog having content available for purchase;
receiving user input indicating selection of some of the content;
calculating a price for the selected product;
requesting payment information from the user;
receiving payment information from the user;
locally manufacturing the media having the selected content; and
locally dispensing the media;
wherein the method is performed without human intervention.

23. The method as recited in claim 22, wherein the payment information received from the user includes credit card information.

24. The method as recited in claim 23, further comprising reading magnetic stripe information from a credit card.

25. The method as recited in claim 22, wherein the payment information received from the user includes debit card information.

26. The method as recited in claim 22, wherein the payment information received from the user includes online account information.

27. The method as recited in claim 22, further comprising verifying an ability of the user to pay.

28. The method as recited in claim 22, further comprising labeling the product without human intervention.

29. The method as recited in claim 22, further comprising packaging the product in a presentation package without human intervention.

30. The method as recited in claim 22, wherein the media is selected from a group consisting of compact disc (CD), digital video disc (DVD), and videotape.

31. The method as recited in claim 22, wherein the content is selected from a group consisting of audio, video, text, software, tables, photos, and combinations thereof.

32. The method as recited in claim 31, further comprising calculating a royalty payment for the selected content.
